(19) United States
(12) Patent Application Publication
(10) Pub. No.: US 2021/0158251 A1
(43) Pub. Date: May 27, 2021

(54) FAIR SHARE IN DISTRIBUTION REQUIREMENTS PLANNING

(71) Applicant: Kinaxis Inc., Kanata (CA)

(72) Inventors: John Howat, Kanata (CA); Rob MacMillan, Kanata (CA); Yankai Zhang, Kanata (CA)

(21) Appl. No.: 17/105,585

(22) Filed: Nov. 26, 2020

Related U.S. Application Data
(63) Continuation-in-part of application No. 16/697,009, filed on Nov. 26, 2019.
(60) Provisional application No. 63/017,070, filed on Apr. 29, 2020.

(51) Int. Cl. G06Q 10/06; G06Q 10/08

(52) U.S. Cl. CPC G06Q 10/06313; G06Q 10/06315; G06Q 10/0875

(57) ABSTRACT

Systems and methods that distribute fairly, limited inventory across multi levels of warehouses, where each warehouse has its own inventory target. The goal is to first ensure that all real demands (e.g. sales orders and forecasts) are satisfied, fair-sharing as needed. Once real demands are satisfied, nodes in the distribution network should be brought up to their safety stock levels fairly: each downstream node should achieve an equal fraction of its desired days of coverage.

### CROSS-REFERENCE TO RELATED APPLICATIONS

This application claims priority on U.S. application Ser. No. 16/697,009 filed Nov. 26, 2019 and U.S. application Ser. No. 63/017,070 filed Apr. 29, 2020, the entirety of each which is incorporated by reference.

### TECHNICAL FIELD

This disclosure relates to the field of supply chains. In particular, it relates to management of demands in a supply chain network.

### BACKGROUND

Warehouse sites have transportation routes between them. Manufacture sites supply inventory to these warehouses. Each warehouses site has its inventory target overtime. There is limited production capacity at the manufacture sites. The limited supply manufactured should be distributed ‘fairly’ to the various warehouse sites. Now, customer demands exist at the various warehouse sites. Furthermore, customer demands can have different priorities, and these elements combine in different ways. For example, the relationship between warehouse sites and manufacture sites are many-to-many. In addition, customer demand is at a higher priority than inventory targets.

### BRIEF SUMMARY

Disclosed herein are systems and methods that distribute fairly, limited inventory across multi levels of warehouses, where each warehouse has its own inventory target.

The systems and methods disclosed herein fairly distribute limited supply to downstream sites. In some embodiments, the fair distribution of limited supply is, first among customer demands, then subsequently, among inventory targets across sites.

Disclosed herein are systems and methods to fairly distribute supply within a distribution network. The goal is to first ensure that all real demands (e.g., sales orders and forecasts) are satisfied, fair-sharing as needed. Once real demands are satisfied, nodes in the distribution network should be brought up to their safety stock levels fairly: each downstream node should achieve an equal fraction of its desired days of coverage.

The benefit of such an approach is that, since safety stock is fairly distributed throughout the network, each distribution node has an equal probability of being able to satisfy a new demand. That is, this can increase the resiliency of a distribution network. At the same time, existing known demands are satisfied to the greatest extent possible given the available supply.

In one aspect, a system comprising: a processor; and a memory storing instructions that, when executed by the processor, configure the system to: collect known supplies and demands; compare total supply and total demand; if the total supply does not equal the total demand, adjust the total supply or the total demand to make the total demand equal the total supply; determine downstream safety stock levels; create a plurality of events; and process the plurality of events by: maintaining each of a set of active demands, a set of active supplies and a set of late demands, for the purpose of ensuring all real demands are satisfied by their need dates; and fair-sharing by a ratio based on demand quantity if required, while simultaneously fair-sharing supply between demand due and demand need dates, by a ratio based on downstream safety stock requirements, when there is sufficient supply to do so.

In some embodiments of the system, the instructions further configure the system to: merge one or more allotments. In some embodiments of the system, the instructions further configure the system to process the plurality of events by chronological sequence; and by the type of event.

In some embodiments of the system, the instructions further configure the system to process demand due events by executing a Multiple Supply Allocation by Downstream Safety Stock Ratio subroutine on the set of active supplies and new demands, the Multiple Supply Allocation by Downstream Safety Stock Ratio subroutine allocating a set of supplies to a set of demands by repeatedly using a Single Supply Allocation by Downstream Safety Stock Ratio subroutine on the set of supplies in non-decreasing order of availability, the Single Supply Allocation by Downstream Safety Stock Ratio subroutine allocating a single supply or portion of supply to a given set of demands so that, once allocated, the safety stock attainment at the set of destinations downstream of each demand are as equal as possible.

In some embodiments of the system, the instructions further configure the system to process supply available events, by: executing a Multiple Supply Allocation by Demand Quantity Ratio in Tiers on the set of active supplies to late demands; executing the Multiple Supply Allocation by Demand Quantity Ratio in Tiers on the set of new supplies to late demands; executing a Multiple Supply Allocation by Downstream Safety Stock Ratio on the set of active supplies to active demands; and executing the Multiple Supply Allocation by Downstream Safety Stock Ratio on the set of new supplies and active demands; wherein: the Multiple Supply Allocation by Demand Quantity Ratio in Tiers allocates a set of supplies to a set of demands by repeatedly using a Multiple Supply Allocation by Demand Quantity Ratio subroutine on the given set of supplies and the highest tier of demands remaining in the given set, where tier refers to the set of outstanding demands with the highest priority among the set of outstanding demands with earliest need date; the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability; the Single Supply Allocation by Demand Quantity Ratio subroutine allocates a single supply or portion of supply to a given set of demands so that each demand in the set is satisfied in as close to the same proportion as possible based on its quantity; the Multiple Supply Allocation by Downstream Safety Stock Ratio allocates a set of supplies to a set of demands by repeatedly using a Single Supply Allocation by Downstream Safety Stock Ratio subroutine on the set of supplies in non-decreasing order of availability; and the Single Supply Allocation by Downstream Safety Stock Ratio allocates a single supply or portion of supply to a given set of demands so that, once allocated, the safety stock attainment at the set of destinations downstream of each demand are as equal as possible.

In some embodiments of the system, the instructions further configure the system to process demand need events, by: comparing the amount of active supply to the amount of newly needed demand; where there is sufficient active supply: executing a Safety Stock Allocation for Needed Demands subroutine; and where there is insufficient active supply: executing a Multiple Supply Allocation by Demand Quantity Ratio subroutine on the set of active supplies and new demands; if any newly needed demand remains unsatisfied: executing a Reclaim subroutine; comparing the amount of active supply to the amount of outstanding newly needed demand; where there is sufficient active supply, executing a Safety Stock Allocation for Needed Demands in Tiers subroutine; and where there is insufficient active supply, executing the Multiple Supply Allocation by Demand Quantity Ratio subroutine on the set of active supplies and newly needed demands; and executing a Multiple Supply Allocation by Downstream Safety Stock Ratio on the set of active supplies and active demands; wherein: the Safety Stock allocation for Needed Demands subroutine allocates a set of supplies to a set of demands by using the Multiple Supply Allocation by Downstream Safety Stock Ratio subroutine on the given set of supplies, except a most recent set of supplies, and the given set of demands; and uses the Multiple Supply Allocation by Demand Quantity Ratio subroutine on the given set of supplies and the given set of demands; the Multiple Supply Allocation by Downstream Safety Stock Ratio subroutine allocates a set of supplies to a set of demands by repeatedly using a Single Supply Allocation by Downstream Safety Stock Ratio subroutine on the set of supplies in non-decreasing order of availability; the Single Supply Allocation by Downstream Safety Stock Ratio subroutine allocates a single supply or portion of supply to a given set of demands so that, once allocated, the safety stock attainment at the set of destinations downstream of each demand are as equal as possible; the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability; the Single Supply Allocation by Demand Quantity Ratio subroutine allocates a single supply or portion of supply to a given set of demands so that each demand in the set is satisfied in as close to the same proportion as possible based on its quantity; the Reclaim subroutine takes a set of demands and attempts to free supply from other later-needed, lower-priority demands to attempt to satisfy the given set of demands instead; and the Safety Stock Allocation for Needed Demands in Tiers subroutine allocates a set of supplies to a set of demands by repeatedly using the Safety Stock Allocation for Needed Demands subroutine on the given set of supplies and the highest tier of demands remaining in the given set, where a tier refers to the set of outstanding demands with the highest priority among the set of outstanding demands with earliest need date.

In another aspect, a computer-implemented method comprising: collecting known supplies and demands; comparing total supply and total demand; if the total supply does not equal the total demand, adjusting the total supply or the total demand to make the total demand equal the total supply; determining downstream safety stock levels; creating a plurality of events; and processing the plurality of events by: maintaining each of a set of active demands, a set of active supplies and a set of late demands, for the purpose of ensuring all real demands are satisfied by their need dates; and fair-sharing by a ratio based on demand quantity if required, while simultaneously fair-sharing supply between demand due and demand need dates, by a ratio based on downstream safety stock requirements, when there is sufficient supply to do so.

In some embodiments, the method further comprises merging one or more allotments. In some embodiments, the method further comprises processing the plurality of events by chronological sequence; and by the type of event.

In some embodiments, the method further comprises processing demand due events by executing a Multiple Supply Allocation by Downstream Safety Stock Ratio subroutine on the set of active supplies and new demands, the Multiple Supply Allocation by Downstream Safety Stock Ratio subroutine allocating a set of supplies to a set of demands by repeatedly using a Single Supply Allocation by Downstream Safety Stock Ratio subroutine on the set of supplies in non-decreasing order of availability, the Single Supply Allocation by Downstream Safety Stock Ratio subroutine allocating a single supply or portion of supply to a given set of demands so that, once allocated, the safety stock attainment at the set of destinations downstream of each demand are as equal as possible.

In some embodiments, the method further comprises processing the supply available events, by: executing the Multiple Supply Allocation by Demand Quantity Ratio in Tiers on the set of active supplies to late demands; executing the Multiple Supply Allocation by Demand Quantity Ratio in Tiers on the set of new supplies to late demands; executing the Multiple Supply Allocation by Downstream Safety Stock Ratio on the set of active supplies to active demands; and executing the Multiple Supply Allocation by Downstream Safety Stock Ratio on the set of new supplies and active demands; wherein: the Multiple Supply Allocation by Demand Quantity Ratio in Tiers allocates a set of supplies to a set of demands by repeatedly using a Multiple Supply Allocation by Demand Quantity Ratio subroutine on the given set of supplies and the highest tier of demands remaining in the given set, where tier refers to the set of outstanding demands with the highest priority among the set of outstanding demands with earliest need date; the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability; the Single Supply Allocation by Demand Quantity Ratio subroutine allocates a single supply or portion of supply to a given set of demands so that each demand in the set is satisfied in as close to the same proportion as possible based on its quantity; the Multiple Supply Allocation by Downstream Safety Stock Ratio allocates a set of supplies to a set of demands by repeatedly using a Single Supply Allocation by Downstream Safety Stock Ratio subroutine on the set of supplies in non-decreasing order of availability; and the Single Supply Allocation by Downstream Safety Stock Ratio allocates a single supply or portion of supply to a given set of demands so that, once allocated, the safety stock attainment at the set of destinations downstream of each demand are as equal as possible.

In some embodiments, the method further comprises processing demand need events, by: comparing the amount of active supply to the amount of newly needed demand; where there is sufficient active supply: executing a Safety Stock Allocation for Needed Demands subroutine; and where there is insufficient active supply: executing a Multiple Supply Allocation by Demand Quantity Ratio subroutine on the set of active supplies and new demands; if any newly needed demand remains unsatisfied: executing a Reclaim subroutine; comparing the amount of active supply to the amount of outstanding newly needed demand; where there is sufficient active supply, executing a Safety Stock Allocation for Needed Demands in Tiers subroutine; and where there is insufficient active supply, executing the Multiple Supply Allocation by Demand Quantity Ratio subroutine on the set of active supplies and newly needed demands; and executing a Multiple Supply Allocation by Downstream Safety Stock Ratio on the set of active supplies and active demands; wherein: the Safety Stock allocation for Needed Demands subroutine allocates a set of supplies to a set of demands by using the Multiple Supply Allocation by Downstream Safety Stock Ratio subroutine on the given set of supplies, except a most recent set of supplies, and the given set of demands; and uses the Multiple Supply Allocation by Demand Quantity Ratio subroutine on the given set of supplies and the given set of demands; the Multiple Supply Allocation by Downstream Safety Stock Ratio subroutine allocates a set of supplies to a set of demands by repeatedly using a Single Supply Allocation by Downstream Safety Stock Ratio subroutine on the set of supplies in non-decreasing order of availability; the Single Supply Allocation by Downstream Safety Stock Ratio subroutine allocates a single supply or portion of supply to a given set of demands so that, once allocated, the safety stock attainment at the set of destinations downstream of each demand are as equal as possible; the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability; the Single Supply Allocation by Demand Quantity Ratio subroutine allocates a single supply or portion of supply to a given set of demands so that each demand in the set is satisfied in as close to the same proportion as possible based on its quantity; the Reclaim subroutine takes a set of demands and attempts to free supply from other later-needed, lower-priority demands to attempt to satisfy the given set of demands instead; and the Safety Stock Allocation for Needed Demands in Tiers subroutine allocates a set of supplies to a set of demands by repeatedly using the Safety Stock Allocation for Needed Demands subroutine on the given set of supplies and the highest tier of demands remaining in the given set, where a tier refers to the set of outstanding demands with the highest priority among the set of outstanding demands with earliest need date.

In yet a another aspect, non-transitory computer-readable storage medium, the computer-readable storage medium including instructions that when executed by a computer, cause the computer to: collect known supplies and demands; compare total supply and total demand; if the total supply does not equal the total demand, adjust the total supply or the total demand to make the total demand equal the total supply; determine downstream safety stock levels; create a plurality of events; and process the plurality by: maintaining each of a set of active demands, a set of active supplies and a set of late demands, for the purpose of ensuring all real demands are satisfied by their need dates; and fair-sharing by a ratio based on demand quantity if required, while simultaneously fair-sharing supply between demand due and demand need dates, by a ratio based on downstream safety stock requirements, when there is sufficient supply to do so.

In some embodiments, the instructions further configure the computer to merge one or more allotments. In some embodiments, the instructions further configure the computer to process the plurality of events by chronological sequence; and by the type of event.

In some embodiments, the instructions further configure the computer to process demand due events by executing a Multiple Supply Allocation by Downstream Safety Stock Ratio subroutine on the set of active supplies and new demands, the Multiple Supply Allocation by Downstream Safety Stock Ratio subroutine allocating a set of supplies to a set of demands by repeatedly using a Single Supply Allocation by Downstream Safety Stock Ratio subroutine on the set of supplies in non-decreasing order of availability, the Single Supply Allocation by Downstream Safety Stock Ratio subroutine allocating a single supply or portion of supply to a given set of demands so that, once allocated, the safety stock attainment at the set of destinations downstream of each demand are as equal as possible.

In some embodiments, the instructions further configure the computer to process the supply available events, by: executing the Multiple Supply Allocation by Demand Quantity Ratio in Tiers on the set of active supplies to late demands; executing the Multiple Supply Allocation by Demand Quantity Ratio in Tiers on the set of new supplies to late demands; executing the Multiple Supply Allocation by Downstream Safety Stock Ratio on the set of active supplies to active demands; and executing the Multiple Supply Allocation by Downstream Safety Stock Ratio on the set of new supplies and active demands; wherein: the Multiple Supply Allocation by Demand Quantity Ratio in Tiers allocates a set of supplies to a set of demands by repeatedly using a Multiple Supply Allocation by Demand Quantity Ratio subroutine on the given set of supplies and the highest tier of demands remaining in the given set, where tier refers to the set of outstanding demands with the highest priority among the set of outstanding demands with earliest need date; the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability; the Single Supply Allocation by Demand Quantity Ratio subroutine allocates a single supply or portion of supply to a given set of demands so that each demand in the set is satisfied in as close to the same proportion as possible based on its quantity; the Multiple Supply Allocation by Downstream Safety Stock Ratio allocates a set of supplies to a set of demands by repeatedly using a Single Supply Allocation by Downstream Safety Stock Ratio subroutine on the set of supplies in non-decreasing order of availability; and the Single Supply Allocation by Downstream Safety Stock Ratio allocates a single supply or portion of supply to a given set of demands so that, once allocated, the safety stock attainment at the set of destinations downstream of each demand are as equal as possible.

In some embodiments, the instructions further configure the computer to process the demand need events, by: comparing the amount of active supply to the amount of newly needed demand; where there is sufficient active supply: executing a Safety Stock Allocation for Needed Demands subroutine; and where there is insufficient active supply: executing a Multiple Supply Allocation by Demand Quantity Ratio subroutine on the set of active supplies and new demands; if any newly needed demand remains unsatisfied: executing a Reclaim subroutine; comparing the amount of active supply to the amount of outstanding newly needed demand; where there is sufficient active supply, executing a Safety Stock Allocation for Needed Demands in Tiers subroutine; and where there is insufficient active supply, executing the Multiple Supply Allocation by Demand Quantity Ratio subroutine on the set of active supplies and newly needed demands; and executing a Multiple Supply Allocation by Downstream Safety Stock Ratio on the set of active supplies and active demands; wherein: the Safety Stock allocation for Needed Demands subroutine allocates a set of supplies to a set of demands by using the Multiple Supply Allocation by Downstream Safety Stock Ratio subroutine on the given set of supplies, except a most recent set of supplies, and the given set of demands; and uses the Multiple Supply Allocation by Demand Quantity Ratio subroutine on the given set of supplies and the given set of demands; the Multiple Supply Allocation by Downstream Safety Stock Ratio subroutine allocates a set of supplies to a set of demands by repeatedly using a Single Supply Allocation by Downstream Safety Stock Ratio subroutine on the set of supplies in non-decreasing order of availability; the Single Supply Allocation by Downstream Safety Stock Ratio subroutine allocates a single supply or portion of supply to a given set of demands so that, once allocated, the safety stock attainment at the set of destinations downstream of each demand are as equal as possible; the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability; the Single Supply Allocation by Demand Quantity Ratio subroutine allocates a single supply or portion of supply to a given set of demands so that each demand in the set is satisfied in as close to the same proportion as possible based on its quantity; the Reclaim subroutine takes a set of demands and attempts to free supply from other later-needed, lower-priority demands to attempt to satisfy the given set of demands instead; and the Safety Stock Allocation for Needed Demands in Tiers subroutine allocates a set of supplies to a set of demands by repeatedly using the Safety Stock Allocation for Needed Demands subroutine on the given set of supplies and the highest tier of demands remaining in the given set, where a tier refers to the set of outstanding demands with the highest priority among the set of outstanding demands with earliest need date.

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

BRIEF DESCRIPTION OF THE SEVERAL VIEWS OF THE DRAWINGS

To easily identify the discussion of any particular element or act, the most significant digit or digits in a reference number refer to the figure number in which that element is first introduced.

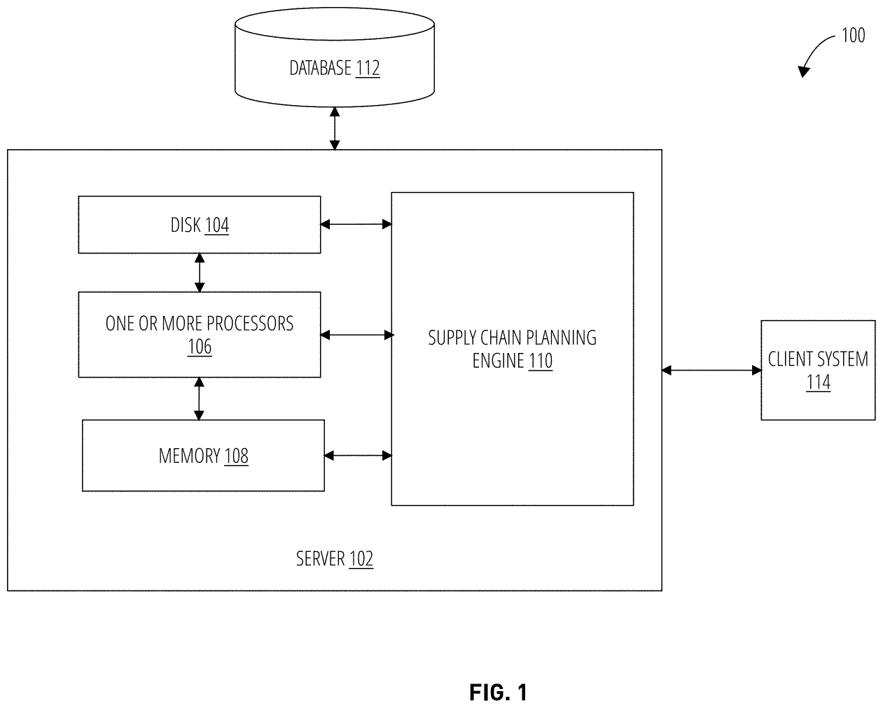

FIG. 1 illustrates a system in accordance with one embodiment.

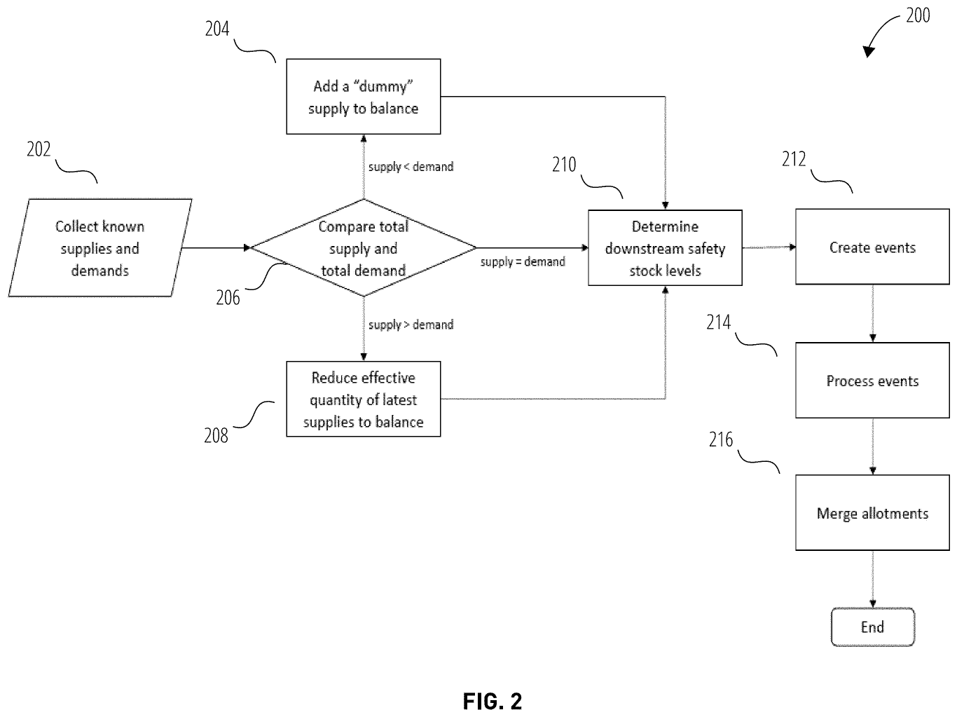

FIG. 2 illustrates a block diagram of fair share in distribution requirements planning in accordance with one embodiment.

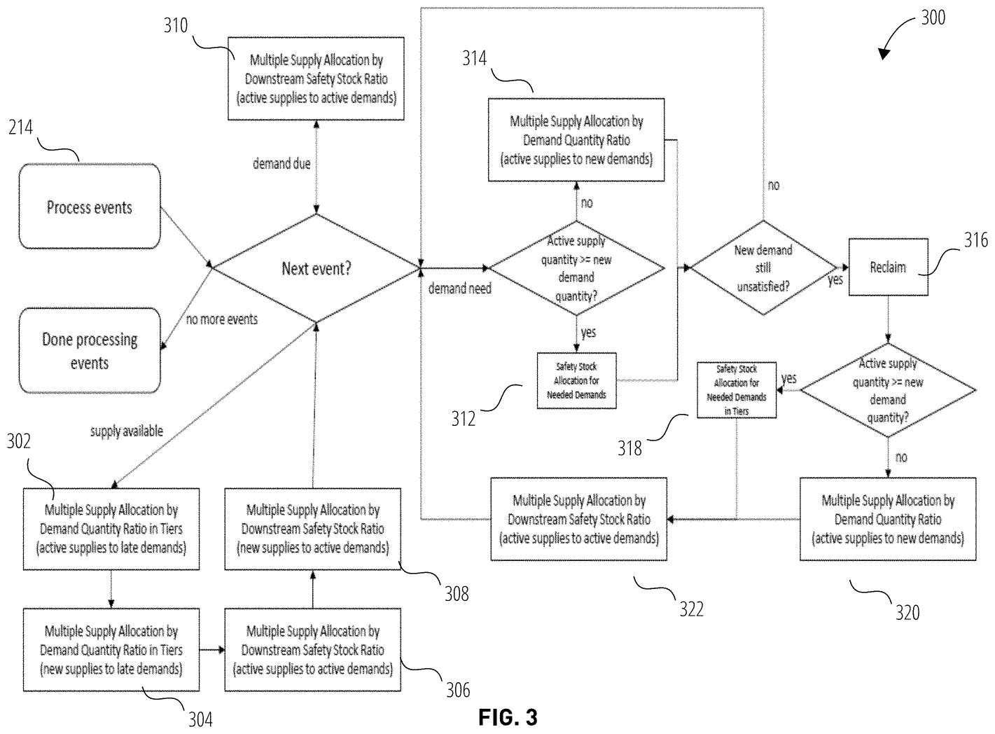

FIG. 3 illustrates a block diagram of processing events in accordance with one embodiment.

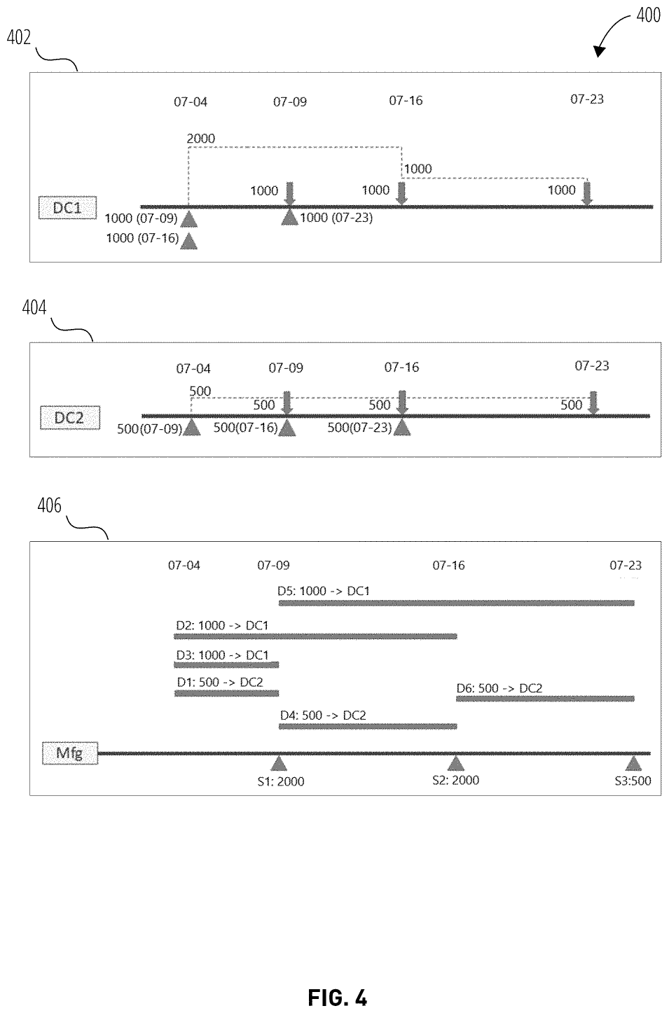

FIG. 4 illustrates an example of fair share in distribution requirements planning in accordance with one embodiment.

### DETAILED DESCRIPTION

FIG. 1 illustrates a system 100 in accordance with one embodiment.

According to the illustrated embodiment, system 100 can include a client system 114, a server 102 and a database 112 coupled as shown in FIG. 1. A user may use client system 114 in order to communicate with server 102 to plan a supply chain. Server 102 can manage one or more engines or other applications for supply chain planning. Database 112 includes any suitable memory, database, or other data storage arrangement that stores data that may be used by server 102.

According to the illustrated embodiment, server 102 may include disk 104, one or more processors 106, memory 108 and a supply chain planning engine 110 coupled as shown in FIG. 2. One or more processors 106 manage the operation of server 102, and may comprise any device operable to accept input, process the input according to predefined rules, and produce an output. In some embodiments, one or more processors 106 may comprise parallel processors in a distributed processing environment.

In some embodiments, memory 108 can be volatile memory, compared with disk 104 which can be non-volatile memory. While database 112 is illustrated as separate from server 102, database 112 can also be integrated into server 102, either as a separate component within server 102, or as part of at least one of memory 108 and disk 104.

System 100 can also include additional features and/or functionality. For example, system 100 can also include additional storage (removable and/or non-removable) including, but not limited to, magnetic or optical disks or tape. Such additional storage is illustrated in FIG. 1 by disk 104 and memory 108. Storage media can include volatile and nonvolatile, removable and non-removable media implemented in any method or technology for storage of information such as computer-readable instructions, data structures, program modules or other data. Disk 104 and memory 108 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

Supply chain planning engine 110 may be configured to execute on one or one or more processors 106 in any suitable manner. Supply chain planning engine 110 generates a supply chain plan. In some embodiments, supply chain planning engine 110 can generate a supply chain plan that satisfies demands in order of priority. The supply chain plan may ensure that a lower priority demand is not satisfied at the expense of a higher priority demand.

Supply chain planning engine 110 can generate a supply chain plan in accordance with input. Input may include, for example, information about demand, supply, or both. Demand information may include, for example, a demand forecast, work orders, work in progress, other information, or any combination thereof. Supply information may include, for example, the amount of supply, the supply lead times, the supply risk, other information, or any combination thereof.

Client system 114 and server 102 may each operate on one or more computers and may include appropriate input devices, output devices, mass storage media, processors, memory, or other components for receiving, processing, storing, and communicating information according to the operation of system 100. As used in this document, the term “computer” refers to any suitable device operable to accept input, process the input according to predefined rules, and produce output.

Client system 114, server 102, and database 112 may be integrated or separated according to particular needs. In some embodiments, the functions of both client system 114 and server 102 are provided using a single computer system, such as a single personal computer. In some embodiments, database 112 may reside within server 102. If any combination of client system 114, server 102, or database 112 are separated, they may be coupled to each other using a local area network (LAN), a metropolitan area network (MAN), a wide area network (WAN), a global computer network such as the Internet, or any other appropriate wireline, optical, wireless, or other link.

Modifications, additions, or omissions may be made to system 100 without departing from the scope of the invention. For example, fewer or other components may perform the operations of system 100. For example, supply chain planning engine 110 may be performed by one component, or the supply chain planning engine 110 may be performed by more than one component. Additionally, functions may be performed using any suitable logic comprising software, hardware, other logic, or any suitable combination of the preceding.

In some embodiments, the computer-implemented method comprises: 1) collecting all known supplies and demands; 2) handling excess and shortage of supply; 3) determining downstream safety stock levels; 4) creating events; 5) processing events; and 6) merging allotments. In some embodiments, merging allotments is optional. FIG. 2 illustrates a block diagram 200 of fair share in distribution requirements planning in accordance with one embodiment.

Step 1: Collecting all known supplies and demands (step 202)

In the first step, all known supplies and demands are collected. Supplies are grouped so that all supplies that are available on the same day are considered as the same supply throughout the rest of the core method.

Step 2: Handling excess and shortage of supply (step 204 and step 208)

After determining the total quantity of supply from the collection, and the total quantity of demand from the collection at step 202, the total quantity of supply and the total quantity of demand are compared at decision block 206.

If supply exceeds demand, then there is an excess supply. This means that some of supply need not actually be used. This is deemed the latest such supply and so the remaining quantities of the latest available supplies are reduced by a total of supply quantity minus demand quantity at step 208, so that the remaining supply quantity equals the demand quantity. The process then moves to step 210.

If demand exceeds supply, then there is a shortage of supply. At step 204, a “dummy supply” in an amount equal to demand quantity minus supply quantity is created that is available at a “future time”—the date of which is unspecified. This “dummy supply” is added to the collection of supplies created at step 202, such that the total supply now equals the total demand. The process then moves to step 210.

If supply equals demand at decision block 206, then the process moves to step 210.

Step 3: Determining downstream safety stock levels (step 210)

For the demands remaining in the collection after the completion of Step 2 (i.e. Step 204, decision block 206 and step 208), a set of unique downstream destinations is determined. For each destination, the safety stock level of the destination is determined for each date in the planning horizon. Alternatively, a cumulative safety stock level is determined at each date in the planning horizon, the cumulative safety stock level is the sum of all downstream levels on each date, offset by lead times between destinations as appropriate.

Step 4: Creation of events (step 212)

There can be three types of events: supply availability events; demand due events; and demand need events.

The difference between demand due dates and demand need dates is as follows. The need date of a demand is the date at which it needs to be satisfied to ensure the that it is on time of its driver demand. The due date of a demand is the date at which it needs to be satisfied for the purposes of maintaining a safety stock.

Safety stock provides a buffer to protect against demand variability by building up inventory levels. As safety stock levels fall (typically due to decreased known volume, in a so-called “days of coverage” configuration, but also because of manual level configuration), the supply previously reserved for safety stock can then be used for demands. Therefore, one can think of a demand that consumes supply previously in safety stock as being offset to the date that the safety stock level rose. This can be thought of the demand due date.

Therefore, the due date refers to the date that a supply is needed to cover safety stock, while the need date refers to the date that supply is needed to actually satisfy the demand.

These events are created by iterating over the supplies and demands in the previous steps. Supplies that are available on the same date are aggregated into a single event. Similarly, demands with equal due dates are aggregated into a single demand due event, even across multiple priorities, and demands with equal need dates and priorities are aggregated into a single demand need event.

The resulting events are combined into a single event list and can be sorted in the following way:
1. By non-decreasing date (the available date for supply availability events, the due date for demand due events, and the need date for demand need events)
2. By type (first demand due events, then supply availability events, then demand need events)
3. By non-decreasing priority (where supplies are defined to have a lower priority than that of any demand and demand due events are taken to have the lowest priority among all demands)

Step 5: Processing events (step 214)

The processing events is a series of subroutines that is described in FIG. 3 below.

Step 6: Merging allotments (step 216)

At the end of the previous step, all supplies and demands are fully allocated. However, there may be cases where there are multiple allocation records that go between the same supply and demand. Therefore, those allocations are merged together by summing up their quantities.

This last step is optional but does result in an easier-to-understand report and may lead to improved performance as fewer records are displayed.

FIG. 3 illustrates a block diagram 300 of processing events (step 214 in FIG. 2) in accordance with one embodiment.

### Event Handling

While processing events (in date sequence using the sorting criteria outlined in step 212), three sets are maintained:
1. The set of active demands. This is the set of demands that are due on, or before, the current date, but needed on, or after, the current date.
2. The set of active supplies. This is the set of supplies that are available on or before the current date, but have not yet been completely allocated.
3. The set of late demands. This is the set of demands that are needed before the current date but have not yet been fully satisfied.

Throughout the method, these sets are maintained so that if a demand is fully satisfied, it is removed from the set of late demands. Similarly, if a supply is fully allocated, it is removed from the set of active supplies. Conversely, during the reclaim subroutine (item 316), supplies and demands could be added to the list of active supplies and active demands, respectively. Note that a demand can still be considered active even if it is fully satisfied.

Handling Supply Availability Events

Recall that a supply event consists of a new set of supplies becoming available on the current date. Four types of allocation strategies can be performed:
1. Use the strategy “Multiple Supply Allocation by Demand Quantity Ratio in Tiers” (item 302) to allocate the set of active supplies to the set of late demands.
2. Use the strategy “Multiple Supply Allocation by Demand Quantity Ratio in Tiers” (item 304) to allocate the new set of supplies to the set of late demands.
3. Use the strategy “Multiple Supply Allocation by Downstream Safety Stock Ratio” (item 306) to allocate the set of active supplies to the set of active demands.
4. Use the strategy “Multiple Supply Allocation by Downstream Safety Stock Ratio” (item 308) to allocate the set of new supplies to the set of active demands.

At this point, if any of the supplies in the new set of supplies still have positive remaining quantity, they are added to the set of active supplies.

Handling Demand Due Events

Recall that a demand due event consists of a new set of demands of potentially different priorities that are all due on the current date. Each of these demands is added to the list of active demands and then the strategy “Multiple Supply Allocation by Downstream Safety Stock Ratio” (item 310) is used to allocate the set of active supplies to the set of active demands.

Handling Demand Need Events

Recall that a demand need event comprises a new set of demands of equal priority that are all needed on the current date. The following allocation strategies can be performed:
1. Attempt the strategy “Safety Stock Allocation for Needed Demands” (item 312) if the set of active supplies is enough to cover the new set of demands. Otherwise, use the strategy “Multiple Supply Allocation by Demand Quantity Ratio” (item 314) to allocate the set of active supplies to the set of new demands.
2. If there are still unsatisfied demands in the set of new demands, then execute the reclaim subroutine (item 316) on the set of new demands. Note that this will generally result in additional supplies being added to the set of active supplies and additional demands being added to the set of active demands.
3. Attempt the strategy “Safety Stock Allocation for Needed Demands in Tiers” (item 318) if the new set of active supplies is enough to cover the new set of demands. Otherwise, use the strategy “Multiple Supply Allocation by Demand Quantity Ratio” (item 320) to allocate the set of active supplies to the set of new demands.
4. At this point, there is an attempt to return any additional supply that was reclaimed unnecessarily. To do this, the strategy “Multiple Supply Allocation by Downstream Safety Stock Ratio” (item 322) is used to allocate the set of active supplies to the set of active demands.

At this point, if any of the new demands still have positive unsatisfied quantity, they are added to the set of late demands.

Below is a description of several subroutines used in handling events, as shown in block diagram 300.

Allocation subroutines

In the allocation subroutines, once the ideal quantity to allocate is calculated, it is further adjusted by existing rules and policies governing allocations: in particular, transportation multiples and allocation multiples, as well as respecting the amount of remaining supply and amount of outstanding demand. Each of these adjustments is tracked on a destination level so as not to introduce undue bias (i.e., always favouring one destination when rounding).

In each of these subroutines, no allocations are performed when there is insufficient remaining supply or unsatisfied demand.

Single Supply Allocation by Demand Quantity Ratio Subroutine (used by Item 302)

This subroutine takes a single supply and a set of demands and splits the supply amongst the demands based on the ratio of the demand quantity to the total demand quantity within the set so that each demand receives as close to the same proportion of supply as possible.

Multiple Supply Allocation by Demand Quantity Ratio Subroutine (Item 314 and Item 320)

This subroutine takes a set of supplies and calls the Single Supply Allocation by Demand Quantity Ratio subroutine for each supply in non-decreasing sequence of available date.

Multiple Supply Allocation by Demand Quantity Ratio in Tiers Subroutine (Item 302 and Item 304)

This subroutine takes a set of supplies and calls the Multiple Supply Allocation by Demand Quantity Ratio subroutine (item 314 and item 320) repeatedly with the highest tier of outstanding demands in the given set of demands. Recall that the highest tier refers to the set of outstanding demands with highest priority among the set of outstanding demands with earliest need date.

Single Supply Allocation by Downstream Safety Stock Ratio Subroutine (Used by Item 306, Item 308, Item 310 and Item 322)

This subroutine takes a single supply and a set of demands and splits the supply amongst the downstream destinations based on the ratio of each downstream safety stock level to the sum of the downstream safety stock levels of the entire set of demands within the set. Only demands that are eligible to receive supply for safety stock are considered: this is the set of demands that are due on or before the supply's available date and needed on or after the supply's available date. Once the amount of supply for each destination is determined, it is divided equally between all demands for that destination. Note that the quantity reserved for each destination is first adjusted by the amount already satisfied so that the total satisfied quantity will be fair after the allocation (as opposed to just the distribution of this particular supply).

Multiple Supply Allocation by Downstream Safety Stock Ratio Subroutine (Item 306, Item 308, Item 310 and Item 322)

This subroutine takes a set of supplies and calls the Single Supply Allocation by Downstream Safety Stock Ratio subroutine for each supply in non-decreasing sequence of available date.

Safety Stock Allocation for Needed Demands (Item 312)

This subroutine takes a set of supplies and set of demands and attempts to allocate supplies to demands in due date sequence. This approach is attempted if the amount of given supply is at least the amount of outstanding demand. The goal is to reduce the instances of “cross-pegging”—where an earlier supply is allocated to a later demand—and therefore improve solution quality.

In order to avoid unnecessarily allocating needlessly early supply, this allocation is performed “back-to-front” (in reverse date sequence) by “protecting” the earliest (portion of) supply from the given set of supplies. The amount to protect is equal to the difference between the amount of remaining supply and the amount of unsatisfied demand in the given sets. It is only permissible to allocate protected supply for the purposes of respecting existing rules and policies governing allocations (as described above in the “Allocation subroutines” section).

This strategy works by executing the Multiple Supply Allocation by Downstream Safety Stock Ratio subroutine (item 306, item 308, item 310 and item 322) on the set of given demands and the set of given supplies except for the latest supply. Any remaining supply is then allocated by invoking the Multiple Supply Allocation by Demand Quantity Ratio subroutine (item 314) on the given set of supplies and the given set of demands.

Safety Stock Allocation for Needed Demands in Tiers (Item 318)

This subroutine takes a set of supplies and set of demands and calls the Safety Stock Allocation for Needed Demands subroutine (item 312) repeatedly with the highest tier of outstanding demands in the given set of demands. Recall that the highest tier refers to the set of outstanding demands with highest priority among the set of outstanding demands with earliest need date.

Reclaim Subroutine (Item 316)

Since the method works by walking through the sequence of events, sometimes a previous decision to fair-share supply for the purposes of safety stock may in fact lead to undesirable results because a real demand may not be satisfied by its need date. This subroutine takes as input a set of demands that must be satisfied.

This subroutine works by repeatedly processing a set of needed demands. The highest tier of demands in this set (including any satisfied demands, to ensure the correct ratio can be used in the case a smaller demand needed on the same date is already satisfied) is processed so that some supplies are disconnected from their current demands and become available for a (possibly) different allocation.

For a given tier (the subset of demands from the given set with highest priority among those with earliest need date), the subroutine iterates through all supplies that are available on or before the need date for that tier. For each supply, the subroutine considers its current allotments and reclaims any allotment that is to a demand in the current tier.

Additionally, the subroutine can reclaim other demands:

First, there is an attempt to reclaim without considering so-called “block priority” (those priorities that apply regardless of need date: for example, a priority defined so that even when needed on a later day than another demand, it still has higher effective priority). This means that reclaim of a demand is allowed only if it is needed after the need date of the current tier of it is needed on the same date but is of lower priority.

Second, if the previous step does not provide sufficient supply to cover the demands in the current tier, the subroutine allows “block priority” to be considered and reclaims by block priority regardless of need date.

Whenever the subroutine reclaims from a demand in an earlier tier (that is, from a demand whose demand need event has been processed), it is added to the list of demands that are now needed and iterate the Reclaim subroutine (item 316) on that set.

If there is a reclaim from a supply, we should reclaim all that we can from that supply even if it exceeds what is to be reclaimed, in order to appropriately redistribute it according to ratios in other subroutines.

### EXAMPLE

FIG. 4 illustrates an example 400 of fair share in distribution requirements planning in accordance with one embodiment.

Consider a single manufacturing site that serves two distribution centers DC1 and DC2. DC1 maintains two weeks of safety stock coverage, while DC2 maintains one week of safety stock coverage. Assume there are no restrictions on lot size and zero lead time, but that allocations are made in whole numbers. The run date is 07-04.

In FIG. 4, the horizontal axis represents time. Furthermore, downward-pointing arrows represent independent demands. The number above the arrow is the demand quantity. In this example, all demands have the same priority. Triangles represent planned supply due dates. The supply is placed according to its due date and the date in parentheses is the corresponding need date. The dashed lines represent the safety stock levels.

The situation at DC1 is shown at 402, while the situation at DC2 is shown at 404. This means that at the manufacturing level, the situation is shown at 406, in which the demands have been drawn as intervals, where the left-hand side is the due date and right-hand side is the need date. The supplies (i.e. S1, S2, S3) below the line represent actual supply availability at the manufacturing site.

This example focuses on Step 5. Here are how the systems and methods proceed:

1. Demand Due Event on 07-04 (D1, D2, D3)

There are no active supplies, so no allocation can happen yet. Add D1, D2, D3 to the list of active demands.

2. Demand Due Event on 07-09 (D4, D5).

There are no active supplies, so no allocation can happen yet. Add D4, D5 to the list of active demands.

3. Supply Available Event on 07-09 (S1).

The set of late demands is currently empty, and so the new supply is allocated to the set of active demands. Observe that there are demands going to both DC1 and DC2, and the ratio of safety stock levels at DC1 and DC2 on 07-09 is 4:1. Since there is a s 2000 supply available from S1, 1600 is reserved for DCI and 400 reserved for DC2. These reservations get split equally among the demands from each destination: D1 and D4 get 200 each and D2, D3, and D5 get 533, 533, and 534 respectively (due to rounding).

4. Demand Need Event on 07-09 (D1, D3)

There is no active supply available and therefore, there will be a need to reclaim some from demands currently satisfying safety stock. In this case, since no other demands have reached their need date, all supply will be reclaimed. This leaves 2000 active supply and 1500 needed demand, which means allocation can occur by due date. The remaining 500 supply that was reclaimed can be redistributed among the other active demands D2, D4, and D5. As before, the safety stock ratio is 4:1 and so the split will be 400 for DC1 and 100 for DC2. This means 200 supply each to D2 and D5 and 100 supply to D4. Observe that the distribution of supply per destination is the same as it was before (1600:400), but now the correct individual demands are receiving supply.

5. Demand Due Event on 07-16 (D6)

There are no active supplies and so D6 is simply added to the list of active demands.

6. Supply Available Event on 07-16 (S2)

The set of active demands now consists of D2, D4, D5, and D6. There are neither active supplies nor late demands, so S2 can be allocated by parent safety stock ratio. Observe that there are demands going to both DC1 and DC2, and the ratio of safety stock levels at DC1 and DC2 on 07-16 is 2:1. However, we have already satisfied 400 at DC1 and 100 at DC2 (during Demand Need Event on 07-09 above). Therefore, the desired split is actually 1267 to DC1 and 733 to DC2 so that the total sent to DC1 is 1667 and to DC2 is 833 (i.e., 2:1). This gets split to 633 for D2, 634 for D5 (or vice versa), and 366 to D4, 367 to D6 (or vice versa).

7. Demand Need Event on 07-16 (D2, D4)

There is no active supply available and therefore there will be a need to reclaim some from demands currently satisfying safety stock. A reclaim is made from S2 only (since a reclaim is made from later supplies first and stopped once enough has been reclaimed) for a total of 2000 reclaimed supply. This leaves 2000 active supply and 1200 needed demand (since these demands received 300 supply from S1 already), which means allocation can be made by due date. The remaining 500 supply that was reclaimed can be redistributed among the other active demands D5 and D6. Recall that D5 already received 200 from S1 during Event 4, and so given the safety stock ratio of 2:1, the desired split is in fact 467 to D5 and 333 to D6. This results in D5 having a total of 467+200=667 supply, while D6 will have a total of 333 (i.e., 2:1).

8. Supply Available Event on 07-23 (S3)

The set of active demands now consists of D5 (unsatisfied quantity of 333) and D6 (unsatisfied quantity of 167). This totals 500, which is precisely the quantity of supply available from S3. Each demand can therefore be fully satisfied.

9. Demand Need Event on 07-23 (D5, D6)

Both of these demands were already satisfied fully in the previous step. No further action needs to be taken.

At this point, the allocation process has finished. A few key observations:
1. Every demand was satisfied on-time.
2. From S1, DC1 has reached 400/2000 safety stock and DC2 has reached 100/500 safety stock. These ratios are equal.
3. From S2, DC1 has reached 667/1000 safety stock and DC2 has reached 333/500 safety stock. These ratios are equal.

Although the algorithms described above including those with reference to the foregoing flow charts have been described separately, it should be understood that any two or more of the algorithms disclosed herein can be combined in any combination. Any of the methods, modules, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner and can be used separately or in combination.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and
a memory storing instructions that, when executed by the processor, configure the system to:
collect known supplies and demands;
compare total supply and total demand;
if the total supply does not equal the total demand, adjust the total supply or the total demand to make the total demand equal the total supply;
determine downstream safety stock levels;
create a plurality of events; and
process the plurality of events by:
maintaining each of a set of active demands, a set of active supplies and a set of late demands, for the purpose of ensuring all real demands are satisfied by their need dates; and
fair-sharing by a ratio based on demand quantity if required, while simultaneously fair-sharing supply between demand due and demand need dates, by a ratio based on downstream safety stock requirements, when there is sufficient supply to do so.

2. The system of claim 1 wherein the instructions further configure the system to:
merge one or more allotments.

3. The system of claim 1, wherein the instructions further configure the system to process the plurality of events by chronological sequence; and by the type of event.

4. The system of claim 3, wherein the instructions further configure the system to process demand due events by executing a Multiple Supply Allocation by Downstream Safety Stock Ratio subroutine on the set of active supplies and active demands, the Multiple Supply Allocation by Downstream Safety Stock Ratio subroutine allocating a set of supplies to a set of demands by repeatedly using a Single Supply Allocation by Downstream Safety Stock Ratio subroutine on the set of supplies in non-decreasing order of availability, the Single Supply Allocation by Downstream Safety Stock Ratio subroutine allocating a single supply or portion of supply to a given set of demands so that, once allocated, the safety stock attainment at the set of destinations downstream of each demand are as equal as possible.

5. System of claim 3, wherein the instructions further configure the system to process supply available events, by:
executing a Multiple Supply Allocation by Demand Quantity Ratio in Tiers on the set of active supplies to late demands;
executing the Multiple Supply Allocation by Demand Quantity Ratio in Tiers on the set of new supplies to late demands;
executing a Multiple Supply Allocation by Downstream Safety Stock Ratio on the set of active supplies to active demands; and
executing the Multiple Supply Allocation by Downstream Safety Stock Ratio on the set of new supplies and active demands;
wherein:
the Multiple Supply Allocation by Demand Quantity Ratio in Tiers allocates a set of supplies to a set of demands by repeatedly using a Multiple Supply Allocation by Demand Quantity Ratio subroutine on the given set of supplies and the highest tier of demands remaining in the given set, where tier refers to the set of outstanding demands with the highest priority among the set of outstanding demands with earliest need date;
the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability;
the Single Supply Allocation by Demand Quantity Ratio subroutine allocates a single supply or portion of supply to a given set of demands so that each demand in the set is satisfied in as close to the same proportion as possible based on its quantity;
the Multiple Supply Allocation by Downstream Safety Stock Ratio allocates a set of supplies to a set of demands by repeatedly using a Single Supply Allocation by Downstream Safety Stock Ratio subroutine on the set of supplies in non-decreasing order of availability; and
the Single Supply Allocation by Downstream Safety Stock Ratio allocates a single supply or portion of supply to a given set of demands so that, once allocated, the safety stock attainment at the set of destinations downstream of each demand are as equal as possible.

6. The system of claim 3, wherein the instructions further configure the system to process demand need events, by:
comparing the amount of active supply to the amount of newly needed demand;
where there is sufficient active supply: executing a Safety Stock Allocation for Needed Demands subroutine; and
where there is insufficient active supply:
executing a Multiple Supply Allocation by Demand Quantity Ratio subroutine on the set of active supplies and new demands;
if any newly needed demand remains unsatisfied:
executing a Reclaim subroutine;
comparing the amount of active supply to the amount of outstanding newly needed demand;
where there is sufficient active supply, executing a Safety Stock Allocation for Needed Demands in Tiers subroutine; and
where there is insufficient active supply, executing the Multiple Supply Allocation by Demand Quantity Ratio subroutine on the set of active supplies and newly needed demands;
and
executing a Multiple Supply Allocation by Downstream Safety Stock Ratio on the set of active supplies and active demands;
wherein:
the Safety Stock allocation for Needed Demands subroutine allocates a set of supplies to a set of demands by using the Multiple Supply Allocation by Downstream Safety Stock Ratio subroutine on the given set of supplies, except a most recent set of supplies, and the given set of demands; and uses the Multiple Supply Allocation by Demand Quantity Ratio subroutine on the given set of supplies and the given set of demands;
the Multiple Supply Allocation by Downstream Safety Stock Ratio subroutine allocates a set of supplies to a set of demands by repeatedly using a Single Supply Allocation by Downstream Safety Stock Ratio subroutine on the set of supplies in non-decreasing order of availability;
the Single Supply Allocation by Downstream Safety Stock Ratio subroutine allocates a single supply or portion of supply to a given set of demands so that, once allocated, the safety stock attainment at the set of destinations downstream of each demand are as equal as possible;
the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability;
the Single Supply Allocation by Demand Quantity Ratio subroutine allocates a single supply or portion of supply to a given set of demands so that each demand in the set is satisfied in as close to the same proportion as possible based on its quantity;
the Reclaim subroutine takes a set of demands and attempts to free supply from other later-needed, lower-priority demands to attempt to satisfy the given set of demands instead; and
the Safety Stock Allocation for Needed Demands in Tiers subroutine allocates a set of supplies to a set of demands by repeatedly using the Safety Stock Allocation for Needed Demands subroutine on the given set of supplies and the highest tier of demands remaining in the given set, where a tier refers to the set of outstanding demands with the highest priority among the set of outstanding demands with earliest need date.

7. A computer-implemented method comprising:
collecting known supplies and demands;
comparing total supply and total demand;
if the total supply does not equal the total demand, adjusting the total supply or the total demand to make the total demand equal the total supply;
determining downstream safety stock levels;
creating a plurality of events; and
processing the plurality of events by:
maintaining each of a set of active demands, a set of active supplies and a set of late demands, for the purpose of ensuring all real demands are satisfied by their need dates; and
fair-sharing by a ratio based on demand quantity if required, while simultaneously fair-sharing supply between demand due and demand need dates, by a ratio based on downstream safety stock requirements, when there is sufficient supply to do so.

8. The method of claim 7 further comprising:
merging one or more allotments.

9. The method of claim 7, further comprising processing the plurality of events by chronological sequence; and by the type of event.

10. The method of claim 9, further comprising:
processing demand due events by executing a Multiple Supply Allocation by Downstream Safety Stock Ratio subroutine on the set of active supplies and active demands, the Multiple Supply Allocation by Downstream Safety Stock Ratio subroutine allocating a set of supplies to a set of demands by repeatedly using a Single Supply Allocation by Downstream Safety Stock Ratio subroutine on the set of supplies in non-decreasing order of availability, the Single Supply Allocation by Downstream Safety Stock Ratio subroutine allocating a single supply or portion of supply to a given set of demands so that, once allocated, the safety stock attainment at the set of destinations downstream of each demand are as equal as possible.

11. The method of claim 9, further comprising processing the supply available events, by:
executing a Multiple Supply Allocation by Demand Quantity Ratio in Tiers on the set of active supplies to late demands;
executing the Multiple Supply Allocation by Demand Quantity Ratio in Tiers on the set of new supplies to late demands;
executing a Multiple Supply Allocation by Downstream Safety Stock Ratio on the set of active supplies to active demands; and
executing a Multiple Supply Allocation by Downstream Safety Stock Ratio on the set of new supplies and active demands;
wherein:
a Multiple Supply Allocation by Demand Quantity Ratio in Tiers allocates a set of supplies to a set of demands by repeatedly using thethethethe Multiple Supply Allocation by Demand Quantity Ratio subroutine on the given set of supplies and the highest tier of demands remaining in the given set, where tier refers to the set of outstanding demands with the highest priority among the set of outstanding demands with earliest need date;
the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability;
the Single Supply Allocation by Demand Quantity Ratio subroutine allocates a single supply or portion of supply to a given set of demands so that each demand in the set is satisfied in as close to the same proportion as possible based on its quantity;
the Multiple Supply Allocation by Downstream Safety Stock Ratio allocates a set of supplies to a set of demands by repeatedly using a Single Supply Allocation by Downstream Safety Stock Ratio subroutine on the set of supplies in non-decreasing order of availability; and
the Single Supply Allocation by Downstream Safety Stock Ratio allocates a single supply or portion of supply to a given set of demands so that, once allocated, the safety stock attainment at the set of destinations downstream of each demand are as equal as possible.

12. The method of claim 9, further comprising processing demand need events, by:
comparing the amount of active supply to the amount of newly needed demand;
where there is sufficient active supply: executing a Safety Stock Allocation for Needed Demands subroutine; and
where there is insufficient active supply:
executing a Multiple Supply Allocation by Demand Quantity Ratio subroutine on the set of active supplies and new demands;
if any newly needed demand remains unsatisfied:
executing a Reclaim subroutine;
comparing the amount of active supply to the amount of outstanding newly needed demand;
where there is sufficient active supply, executing a Safety Stock Allocation for Needed Demands in Tiers subroutine; and
where there is insufficient active supply, executing the Multiple Supply Allocation by Demand Quantity Ratio subroutine on the set of active supplies and newly needed demands;
and
executing a Multiple Supply Allocation by Downstream Safety Stock Ratio on the set of active supplies and active demands;
wherein:
the Safety Stock allocation for Needed Demands subroutine allocates a set of supplies to a set of demands by using the Multiple Supply Allocation by Downstream Safety Stock Ratio subroutine on the given set of supplies, except a most recent set of supplies, and the given set of demands; and uses the Multiple Supply Allocation by Demand Quantity Ratio subroutine on the given set of supplies and the given set of demands;
the Multiple Supply Allocation by Downstream Safety Stock Ratio subroutine allocates a set of supplies to a set of demands by repeatedly using a Single Supply Allocation by Downstream Safety Stock Ratio subroutine on the set of supplies in non-decreasing order of availability;
the Single Supply Allocation by Downstream Safety Stock Ratio subroutine allocates a single supply or portion of supply to a given set of demands so that, once allocated, the safety stock attainment at the set of destinations downstream of each demand are as equal as possible;
the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability;
the Single Supply Allocation by Demand Quantity Ratio subroutine allocates a single supply or portion of supply to a given set of demands so that each demand in the set is satisfied in as close to the same proportion as possible based on its quantity;
the Reclaim subroutine takes a set of demands and attempts to free supply from other later-needed, lower-priority demands to attempt to satisfy the given set of demands instead; and
the Safety Stock Allocation for Needed Demands in Tiers subroutine allocates a set of supplies to a set of demands by repeatedly using the Safety Stock Allocation for Needed Demands subroutine on the given set of supplies and the highest tier of demands remaining in the given set, where a tier refers to the set of outstanding demands with the highest priority among the set of outstanding demands with earliest need date.

13. A non-transitory computer-readable storage medium, the computer-readable storage medium including instructions that when executed by a computer, cause the computer to:
collect known supplies and demands;
compare total supply and total demand;
if the total supply does not equal the total demand, adjust the total supply or the total demand to make the total demand equal the total supply;
determine downstream safety stock levels;
create a plurality of events; and
process the plurality by:
maintaining each of a set of active demands, a set of active supplies and a set of late demands, for the purpose of ensuring all real demands are satisfied by their need dates; and
fair-sharing by a ratio based on demand quantity if required, while simultaneously fair-sharing supply between demand due and demand need dates, by a ratio based on downstream safety stock requirements, when there is sufficient supply to do so.

14. The computer-readable storage medium of claim 13 wherein the instructions further configure the computer to:
merge one or more allotments.

15. The computer-readable storage medium of claim 13, wherein the instructions further configure the computer to: process the plurality of events by chronological sequence; and by the type of event.

16. The computer-readable storage medium of claim 15, wherein the instructions further configure the computer to:
process demand due events by executing a Multiple Supply Allocation by Downstream Safety Stock Ratio subroutine on the set of active supplies and active demands, the Multiple Supply Allocation by Downstream Safety Stock Ratio subroutine allocating a set of supplies to a set of demands by repeatedly using a Single Supply Allocation by Downstream Safety Stock Ratio subroutine on the set of supplies in non-decreasing order of availability, the Single Supply Allocation by Downstream Safety Stock Ratio subroutine allocating a single supply or portion of supply to a given set of demands so that, once allocated, the safety stock attainment at the set of destinations downstream of each demand are as equal as possible.

17. The computer-readable storage medium of claim 15, the instructions further configure the computer to: process the supply available events, by:
executing a Multiple Supply Allocation by Demand Quantity Ratio in Tiers on the set of active supplies to late demands;
executing the Multiple Supply Allocation by Demand Quantity Ratio in Tiers on the set of new supplies to late demands;
executing a Multiple Supply Allocation by Downstream Safety Stock Ratio on the set of active supplies to active demands; and
executing a Multiple Supply Allocation by Downstream Safety Stock Ratio on the set of new supplies and active demands;
wherein:
a Multiple Supply Allocation by Demand Quantity Ratio in Tiers allocates a set of supplies to a set of demands by repeatedly using thethethethe Multiple Supply Allocation by Demand Quantity Ratio subroutine on the given set of supplies and the highest tier of demands remaining in the given set, where tier refers to the set of outstanding demands with the highest priority among the set of outstanding demands with earliest need date;
the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability;
the Single Supply Allocation by Demand Quantity Ratio subroutine allocates a single supply or portion of supply to a given set of demands so that each demand in the set is satisfied in as close to the same proportion as possible based on its quantity;
the Multiple Supply Allocation by Downstream Safety Stock Ratio allocates a set of supplies to a set of demands by repeatedly using a Single Supply Allocation by Downstream Safety Stock Ratio subroutine on the set of supplies in non-decreasing order of availability; and
the Single Supply Allocation by Downstream Safety Stock Ratio allocates a single supply or portion of supply to a given set of demands so that, once allocated, the safety stock attainment at the set of destinations downstream of each demand are as equal as possible.

18. The computer-readable storage medium of claim 15, the instructions further configure the computer to: process the demand need events, by:
comparing the amount of active supply to the amount of newly needed demand;
where there is sufficient active supply: executing a Safety Stock Allocation for Needed Demands subroutine; and
where there is insufficient active supply:
executing a Multiple Supply Allocation by Demand Quantity Ratio subroutine on the set of active supplies and new demands;
if any newly needed demand remains unsatisfied:
executing a Reclaim subroutine;
comparing the amount of active supply to the amount of outstanding newly needed demand;
where there is sufficient active supply, executing a Safety Stock Allocation for Needed Demands in Tiers subroutine; and
where there is insufficient active supply, executing the Multiple Supply Allocation by Demand Quantity Ratio subroutine on the set of active supplies and newly needed demands;
and
executing a Multiple Supply Allocation by Downstream Safety Stock Ratio on the set of active supplies and active demands;
wherein:
the Safety Stock allocation for Needed Demands subroutine allocates a set of supplies to a set of demands by using the Multiple Supply Allocation by Downstream Safety Stock Ratio subroutine on the given set of supplies, except a most recent set of supplies, and the given set of demands; and uses the Multiple Supply Allocation by Demand Quantity Ratio subroutine on the given set of supplies and the given set of demands;
the Multiple Supply Allocation by Downstream Safety Stock Ratio subroutine allocates a set of supplies to a set of demands by repeatedly using a Single Supply Allocation by Downstream Safety Stock Ratio subroutine on the set of supplies in non-decreasing order of availability;
the Single Supply Allocation by Downstream Safety Stock Ratio subroutine allocates a single supply or portion of supply to a given set of demands so that, once allocated, the safety stock attainment at the set of destinations downstream of each demand are as equal as possible;
the Multiple Supply Allocation by Demand Quantity Ratio subroutine allocates a set of supplies to a set of demands by repeatedly using a Single Supply Allocation by Demand Quantity Ratio subroutine on the set of supplies in non-decreasing order of availability;
the Single Supply Allocation by Demand Quantity Ratio subroutine allocates a single supply or portion of supply to a given set of demands so that each demand in the set is satisfied in as close to the same proportion as possible based on its quantity;
the Reclaim subroutine takes a set of demands and attempts to free supply from other later-needed, lower-priority demands to attempt to satisfy the given set of demands instead; and
the Safety Stock Allocation for Needed Demands in Tiers subroutine allocates a set of supplies to a set of demands by repeatedly using the Safety Stock Allocation for Needed Demands subroutine on the given set of supplies and the highest tier of demands remaining in the given set, where a tier refers to the set of outstanding demands with the highest priority among the set of outstanding demands with earliest need date.
